(19) United States
(12) Patent Application Publication
(10) Pub. No.: US 2025/0163601 A1
(43) Pub. Date: May 22, 2025

(54) METHOD FOR SETTING FORWARD/BACKWARD MOVEMENT RECIPE FOR SHIELDING BODY, AND PLATING APPARATUS

(71) Applicant: EBARA CORPORATION, Tokyo (JP)

(72) Inventors: Masayuki FUJIKI, Tokyo (JP); Fumihiro NIIJIMA, Tokyo (JP); Yosuke NAGASAWA, Tokyo (JP); Kazuma IDEGUCHI, Tokyo (JP)

(21) Appl. No.: 18/885,284

(22) Filed: Sep. 13, 2024

(30) Foreign Application Priority Data
Nov. 20, 2023 (JP) 2023-196616

(51) Int. Cl. C25D 17/00; C25D 21/12

(52) U.S. Cl. CPC C25D 17/008; C25D 21/12

(57) ABSTRACT

There is provided method and a plating apparatus capable of improving uniformity of a plating film formed on a substrate. There is proposed a method for, in a computer, setting a forward/backward movement recipe for a shielding body in a plating apparatus, the plating apparatus including the shielding body, the shielding body being movable to a shielding position interposed between a plating target surface of a substrate and an anode and to a retracted position retracted from between the plating target surface of the substrate and the anode; and the method includes steps of: acquiring a resist pattern of the substrate, calculating a plating growth coefficient for each certain-angle area of the substrate based on the acquired resist pattern, and setting the forward/backward movement recipe for the shielding body based on the calculated plating growth coefficient for each certain-angle area.

### TECHNICAL FIELD

The present application relates to a method for setting a forward/backward movement recipe for a shielding body, and a plating apparatus.

### BACKGROUND ART

As an example of a plating apparatus, a so-called dip-type plating apparatus in which a substrate and an anode are vertically arranged is known (see, for example, PTL 1). Further, as another example of the plating apparatus, a cup-type electrolytically plating apparatus is known (see, for example, PTL 2). In the cup-type electrolytically plating apparatus, a conductive film (plating film) is precipitated on the surface of a substrate, by immersing a substrate (for example, a semiconductor wafer), which is held by a substrate holder with a plating target surface facing downward, into plating solution, and applying voltage between the substrate and an anode.

In the plating apparatus, generally, a user sets in advance parameters, such as a plating current value and a plating time, as a plating treatment recipe, based on a target plating film thickness and an actual plating area of a substrate to be plated, and plating treatment is applied based on the set treatment recipe. Further, it is also performed to detect a parameter related to a plating film thickness by a sensor to measure the film thickness of a plating film, and adjust plating conditions during plating treatment. In PTL 2, it is proposed to provide a shielding body capable of moving forward/backward between a plating target surface of a substrate and an anode to adjust plating conditions.

### CITATION LIST

### Patent Literature

PTL 1: Japanese Patent Laid-Open No. 2005-29863
PTL 2: Japanese Patent No. 7074937

### SUMMARY OF INVENTION

### Technical Problem

By causing a shielding body to move between a shielding position, which is interposed between a plating target surface of a substrate and an anode, and a retracted position retracted from between the plating target surface and the anode, it is possible to adjust the growth speed of a plating film on a specific part. It is conceivable to cause such a shielding body to move based on a detected value that is detected during plating treatment, but it is possible to, by specifying movement in advance as a part of a plating treatment recipe, improve control efficiency and also improve uniformity of a plating film.

In view of the above situation, one object of the present application is to propose a plating apparatus capable of improving uniformity of a plating film formed on a substrate.

### Solution to Problem

According to one embodiment, there is proposed a method for, in a computer, setting a forward/backward movement recipe for a shielding body in a plating apparatus, the plating apparatus including the shielding body, the shielding body being movable to a shielding position interposed between a plating target surface of a substrate and an anode and to a retracted position retracted from between the plating target surface of the substrate and the anode; and the method includes steps of: acquiring a resist pattern of the substrate, calculating a plating growth coefficient for each certain-angle area of the substrate based on the acquired resist pattern, and setting the forward/backward movement recipe for the shielding body based on the calculated plating growth coefficient for each certain-angle area.

### BRIEF DESCRIPTION OF DRAWINGS

FIG. 1 is a perspective view illustrating an overall configuration of a plating apparatus of the present embodiment;

FIG. 2 is a plan view illustrating the overall configuration of the plating apparatus of the present embodiment;

FIG. 3 is a longitudinal sectional view schematically illustrating a configuration of a plating module of the present embodiment;

FIG. 4 is a schematic diagram of a shielding body and a substrate of the present embodiment when seen from below;

FIG. 5 is a flowchart illustrating an example of a method for setting a forward/backward movement recipe by a control module;

FIG. 6 is a graph illustrating an example of plating growth coefficients;

FIG. 7 is a diagram illustrating an example of an area on a plating target surface used for calculation of a plating growth coefficient;

FIG. 8 is a schematic functional block diagram of the control module in the present embodiment;

FIG. 9 is a schematic functional block diagram of a machine learning apparatus in the present embodiment;

FIG. 10 is a graph illustrating an example of a forward/backward movement position of the shielding body for each angular position of the substrate, as the forward/backward movement recipe; and

FIG. 11 is a diagram illustrating an example of display of the plating growth coefficient for each certain-angle area or the forward/backward movement recipe for the shielding body on a display section.

### DESCRIPTION OF EMBODIMENT

Hereinafter, an embodiment of the present invention will be described with reference to the drawings. In the drawings described below, the same or corresponding components are denoted with the same reference signs and will not be described in duplicate.

### Overall Configuration of Plating Apparatus

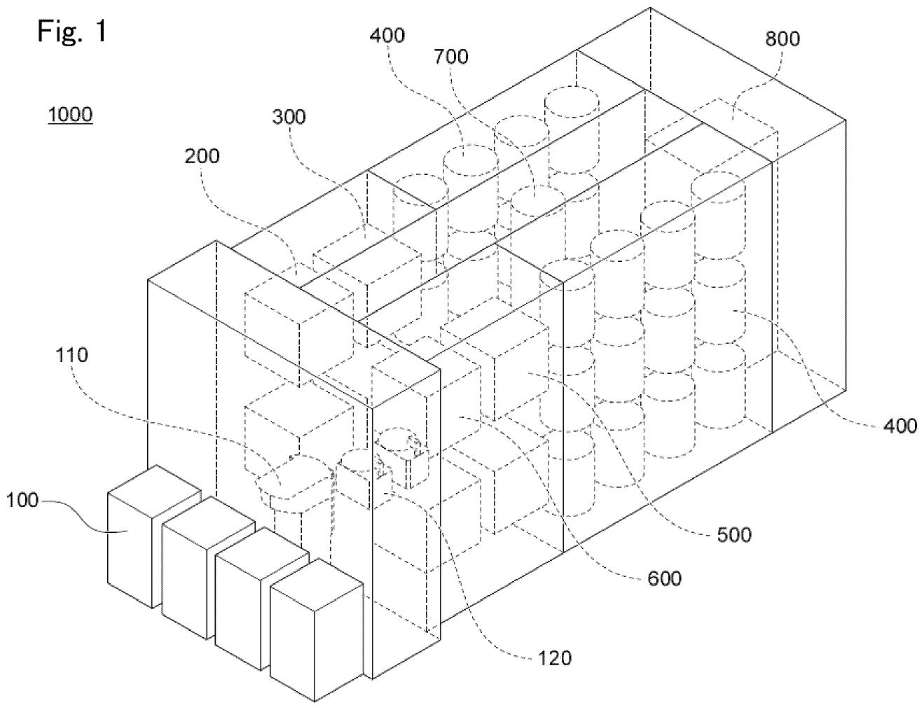

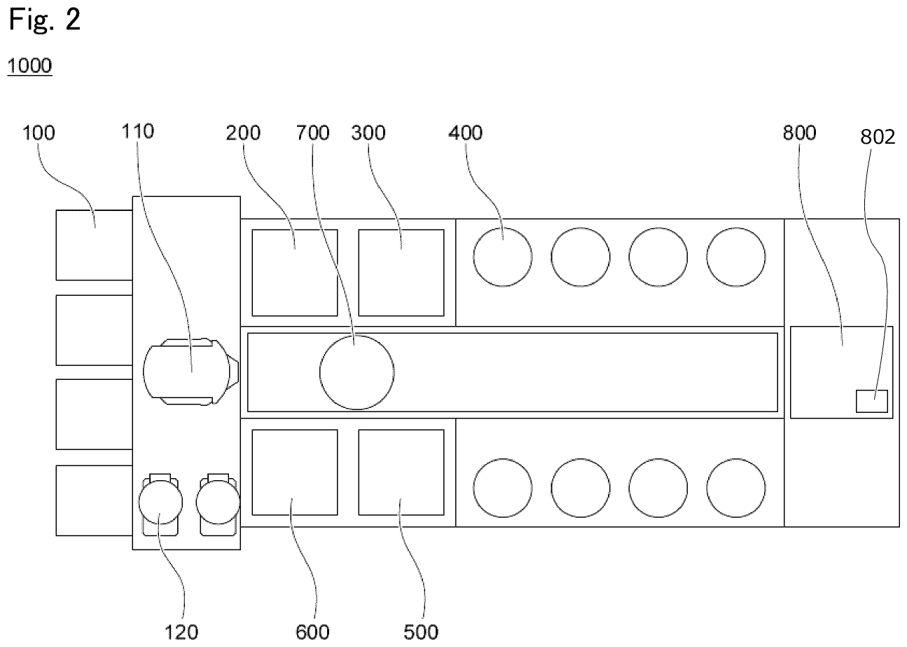

FIG. 1 is a perspective view illustrating an overall configuration of a plating apparatus of the present embodiment. FIG. 2 is a plan view illustrating the overall configuration of the plating apparatus of the present embodiment. The plating apparatus of the present embodiment is used to apply plating treatment to a substrate. As the substrate, a square-shaped substrate and a circular-shaped substrate are included. As illustrated in FIGS. 1 and 2, a plating apparatus 1000 includes load ports 100, a transfer robot 110, aligners 120, pre-wet modules 200, pre-soak modules 300, plating modules 400, cleaning modules 500, spin rinse dryers 600, a transfer device 700, and a control module (controller) 800.

Each load port 100 is a module for loading a substrate, which is housed in a cassette, such as a FOUP not illustrated, and is a target to be plated, to the plating apparatus 1000 and carrying the substrate out of the plating apparatus 1000 to the cassette. While the four load ports 100 are arranged in the horizontal direction in the present embodiment, the number and arrangement of load ports 100 are arbitrary. The transfer robot 110 is a robot for transferring a substrate and is configured to hand over the substrate among the load port 100, the aligners 120, the pre-wet modules 200, and the spin rinse dryers 600. At the time of transferring a substrate between the transfer robot 110 and the transfer device 700, the substrate can be handed over via a temporary placement table not illustrated. Each aligner 120 is a module for adjusting a position of an orientation flat, a notch, or the like of the substrate in a predetermined direction. While the two aligners 120 are arranged in the horizontal direction in the present embodiment, the number and arrangement of aligners 120 are arbitrary.

Each pre-wet module 200 wets a plating target surface of a substrate before being plated, with treatment liquid such as pure water or deaerated water to replace air inside a pattern formed on the surface of the substrate with the treatment liquid. The pre-wet module 200 is configured to apply pre-wet treatment that facilitates supply of plating solution into the inside of the pattern by replacing the treatment liquid inside the pattern with the plating solution during plating. While the two pre-wet modules 200 are arranged in the vertical direction in the present embodiment, the number and arrangement of pre-wet modules 200 are arbitrary.

Each pre-soak module 300 is configured to apply pre-soak treatment of etching away an oxidized film with a large electrical resistance existing on a surface of a seed layer or the like that is formed on the plating target surface of a substrate before being treated, with treatment liquid such as sulfuric acid or hydrochloric acid to clean or activate the surface of a plating base, for example. While the two pre-soak modules 300 are arranged in the vertical direction in the present embodiment, the number and arrangement of pre-soak modules 300 are arbitrary.

The plating modules 400 apply plating treatment to a substrate. In the present embodiment, there are arranged two sets of twelve plating modules 400, each set including three in the vertical direction and four in the horizontal direction, a total of twenty-four plating modules 400 being provided. The number and arrangement of plating modules 400, however, are arbitrary.

Each cleaning module 500 is configured to apply cleaning treatment to a substrate to remove the plating solution or the like remaining on the substrate after plating treatment. While the two cleaning modules 500 are arranged in the vertical direction in the present embodiment, the number and arrangement of cleaning modules 500 are arbitrary. The spin rinse dryers 600 are modules for rotating a substrate after cleaning treatment at a high speed to dry the substrate. While the two spin rinse dryers 600 are arranged in the vertical direction in the present embodiment, the number and arrangement of spin rinse dryers 600 are arbitrary.

The transfer device 700 is a device for transferring a substrate among the plurality of modules inside the plating apparatus 1000. The control module 800 is configured to control the plurality of modules in the plating apparatus 1000 and can be configured of, for example, a general computer or a dedicated computer that includes input/output interfaces with an operator.

An example of a sequence of a plating process by the plating apparatus 1000 will be described. First, a substrate housed in a cassette is loaded onto the load port 100. Then, the transfer robot 110 takes the substrate out of the cassette on the load port 100 and transfers the substrate to the aligners 120. The aligner 120 adjusts the position of an orientation flat, a notch, or the like of the substrate in the predetermined direction. The transfer robot 110 hands over the substrate the direction of which has been adjusted by the aligners 120 to the transfer device 700.

The transfer device 700 hands over the substrate received from the transfer robot 110 to the pre-wet modules 200. The pre-wet modules 200 apply pre-wet treatment to the substrate. The transfer device 700 transfers the substrate to which the pre-wet treatment has been applied, to the pre-soak modules 300. The pre-soak modules 300 apply pre-soak treatment to the substrate. The transfer device 700 transfers the substrate to which the pre-soak treatment has been applied, to the plating modules 400. The plating modules 400 apply plating treatment to the substrate.

The transfer device 700 transfers the substrate to which the plating treatment has been applied, to the cleaning modules 500. The cleaning modules 500 apply cleaning treatment to the substrate. The transfer device 700 transfers the substrate to which the cleaning treatment has been applied, to the spin rinse dryers 600. The spin rinse dryers 600 apply drying treatment to the substrate. The transfer robot 110 receives the substrate from the spin rinse dryers 600 and transfers the substrate to which the drying treatment has been applied, to the cassette on the load port 100. Finally, the cassette housing the substrate is unloaded from the load port 100.

### Configuration of Plating Module

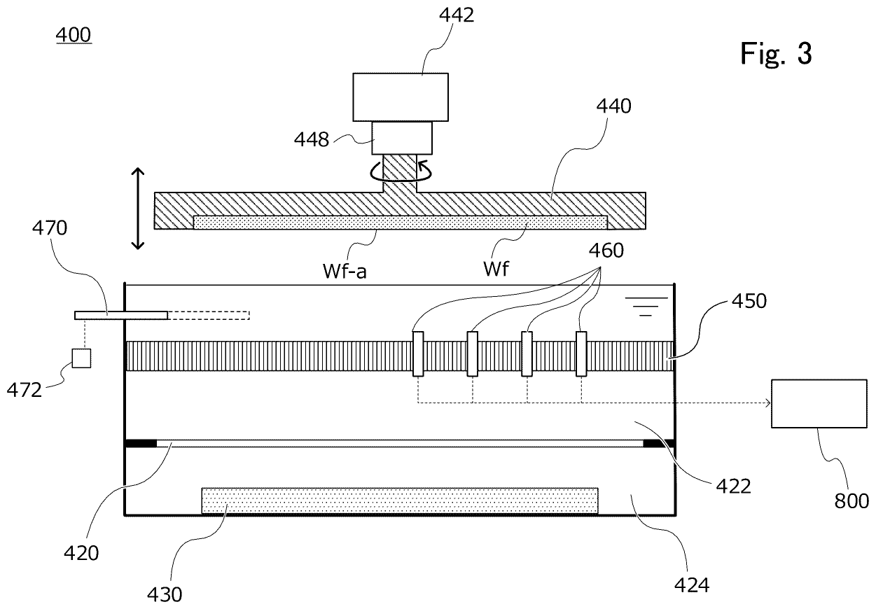

Next, a configuration of each plating module 400 will be described. Since the twenty-four plating modules 400 in the present embodiment have the same configuration, only one plating module 400 alone will be described. FIG. 3 is a longitudinal sectional view schematically illustrating the configuration of the plating module 400 of the present embodiment. As illustrated in FIG. 3, the plating module 400 includes a plating tank 410 for storing the plating solution. The plating tank 410 is configured with a top-open cylindrical tank, and includes an unillustrated outer tank provided around the cylindrical tank so that the plating solution overflowing from the upper edge of the cylindrical tank is accumulated.

The plating module 400 includes a substrate holder 440 that holds a substrate Wf in a state of a plating target surface Wf-a being oriented downward. The substrate holder 440 includes a power supply contact point to supply power from an unillustrated power supply to the substrate Wf. The plating module 400 includes a raising/lowering mechanism 442 for causing the substrate holder 440 to ascend or descend. Further, in the present embodiment, the plating module 400 includes a rotation mechanism 448 that rotates the substrate holder 440 around the vertical axis. Each of the raising/lowering mechanism 442 and the rotation mechanism 448 can be realized by a known mechanism, for example, a motor.

The plating module 400 includes a membrane 420 that separates the inside of the plating tank 410 in the vertical direction. The inside of the plating tank 410 is divided into a cathode region 422 and an anode region 424 by the membrane 420. Each of the cathode region 422 and the anode region 424 is filled with the plating solution. Though an example where the membrane 420 is provided is described in the present embodiment, the membrane 420 need not be provided. On the bottom surface of the plating tank 410, which is in the anode region 424, an anode 430 is provided.

In the cathode region 422, a resistor 450 facing the membrane 420 is disposed. The resistor 450 is a member for uniforming plating treatment on the plating target surface Wf-a of the substrate Wf. The resistor 450 is a resistor against a current flowing between the anode 430 and the substrate Wf, and, as an example, it is made of electrical insulation material in which a plurality of holes are formed, for example, PVC (polyvinyl chloride). Note that the plating module 400 need not include the resistor 450.

In the present embodiment, sensors 460 are provided in the cathode region 422. As an example, the sensors 460 are supported by the plating tank 410 or the resistor 450. Note that the sensors 460 may be immovably fixed and supported or may be supported movably in the horizontal direction or the vertical direction. In the present embodiment, the plurality of sensors 460 are provided in the radial direction of the substrate Wf. Detection signals by the sensors 460 are input to the control module 800. In the present embodiment, the sensors 460 and the control module 800 correspond to an example of “a film thickness measurement module” for measuring the film thickness of a plating film formed on the plating target surface Wf-a of the substrate Wf. The sensors 460 are for detecting a parameter related to the plating film formed on the plating target surface Wf-a of the substrate Wf. As an example, distance sensors for measuring a distance between the sensors 460 and the substrate Wf (the plating film) or displacement sensors for measuring displacement of the plating target surface Wf-a of the substrate Wf can be adopted. As the sensors 460, sensors for estimating a plating film forming speed (a growth speed) as a parameter related to the film thickness of a plating film may be adopted. Specifically, for example, optical sensors, electric potential sensors, or magnetic field sensors of a white-light confocal type or the like, or an eddy current type sensor can be used as the sensors 460.

In the case of using electrical potential sensors as the sensors 460, it is preferred that the sensors 460 are provided between the substrate Wf and the anode 430. In other words, it is preferred that the sensors 460 are provided at positions overlapping with the substrate Wf and the anode 430 when seen in a direction vertical to the plating target surface Wf-a of the substrate Wf. Further, it is preferred to provide at least one electrical potential sensor (not illustrated) for reference in the plating tank 410, and it is preferred to arrange the electrical potential sensor for reference outside an area between the substrate Wf and the anode 430. In other words, it is preferred to provide the electrical potential sensor for reference at a position not overlapping with the substrate Wf and the anode 430 when seen in the direction vertical to the plating target surface Wf-a of the substrate Wf. The control module 800 can measure the film thickness of a plating film formed on the plating target surface Wf-a, based on electrical potential differences between the sensors 460 which are electrical potential sensors and the electrical potential sensor for reference.

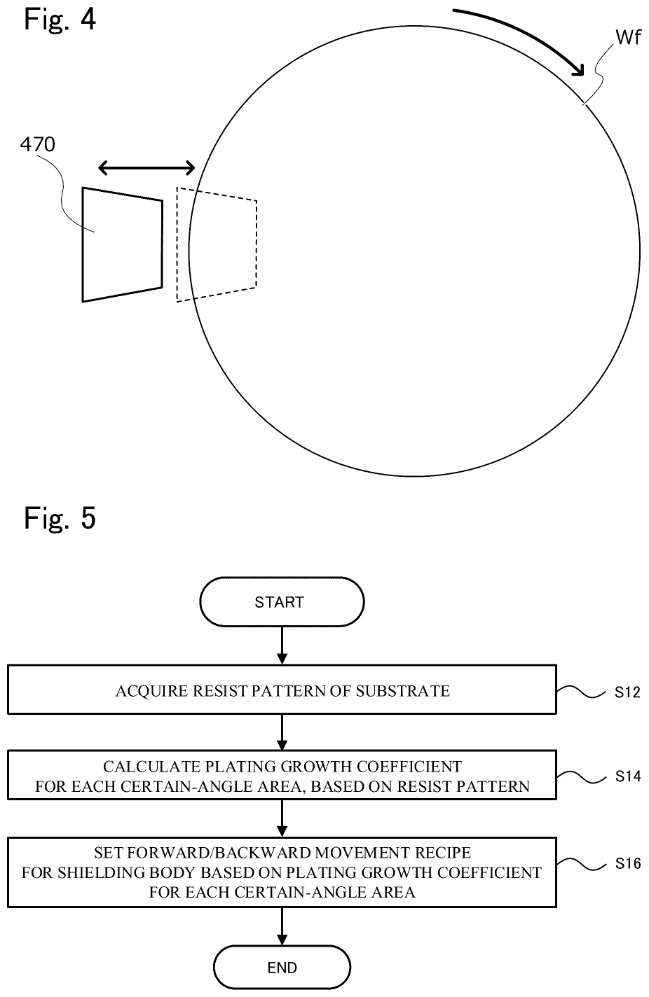

In the cathode region 422, a shielding body 470 for shielding the current flowing from the anode 430 to the substrate Wf is provided. The shielding body 470 is a substantially plate-shaped member, for example, made of a dielectric material. FIG. 4 is a schematic diagram of the shielding body 470 and the substrate Wf of the present embodiment when seen from below. Note that the substrate holder 440 that holds the substrate Wf is not illustrated in FIG. 4. The shielding body 470 is configured to be movable by a drive mechanism 472 (see FIG. 3) to a shielding position (a position denoted by a broken line in FIGS. 3 and 4) interposed between the plating target surface Wf-a of the substrate Wf and the anode 430 and to a retracted position (a position denoted by a solid line in FIGS. 3 and 4) retracted from between the plating target surface Wf-a and the anode 430. In other words, the shielding body 470 is configured to be movable to the shielding position below the plating target surface Wf-a and to the retracted position away from a location below the plating target surface Wf-a. The drive mechanism 472 may be configured to be capable of adjusting the shielding position of the shielding body 470 between the plating target surface Wf-a and the anode 430 to adjust the amount of shielding by the shielding body 470. The drive mechanism 472 can be realized by a known mechanism such as a motor or a solenoid and is controlled by the control module 800. In the example illustrated in FIGS. 3 and 4, the shielding body 470 shields a part of an outer area of the plating target surface Wf-a of the substrate Wf in the circumferential direction, at the shielding position. Further, in the example illustrated in FIG. 4, the shielding body 470 is formed in a such a tapered shape that is gradually thinner toward the center of the substrate Wf. The shielding body 470, however, is not limited to such an example, and a shielding body in any shape that is specified in advance based on experiments and the like can be used.

### Plating Treatment

Next, plating treatment by the plating module 400 of the present embodiment will be described in more detail. By immersing the substrate Wf in the plating solution in the cathode region 422 with the raising/lowering mechanism 442, the substrate Wf is exposed to the plating solution. By applying voltage between the anode 430 and the substrate Wf in this state, the plating module 400 can apply plating treatment to the plating target surface Wf-a of the substrate Wf. In the present embodiment, the plating treatment is applied while the substrate holder 440 is being rotated with the rotation mechanism 448. Through the plating treatment, a conductive film (a plating film) is precipitated on the plating target surface Wf-a of the substrate Wf. In the present embodiment, the plating film formed on the plating target surface Wf-a is detected in real time by the sensor 460 during the plating treatment. Then, the control module 800 measures the film thickness of the plating film based on values detected by the sensors 460. Thereby, change in the film thickness of the plating film formed on the plating target surface Wf-a of the substrate Wf during the plating treatment can be measured in real time.

Further, in the present embodiment, the plating modules 400 includes the plurality of sensors 460 for measuring the film thickness of a plating film and can measure the film thickness of a plating film at a plurality of places on the plating target surface Wf-a. Further, by performing detection by the sensors 460, being accompanied by rotation of the substrate holder 440 (the substrate Wf), it is possible to change the positions of detection by the sensors 460, and it is also possible to measure the film thickness at a plurality of points on the substrate Wf in the circumferential direction or the film thickness of the whole area in the circumferential direction.

The plating modules 400 may change the speed of rotation of the substrate Wf by the rotation mechanism 448 during plating treatment. As an example, the plating modules 400 may cause the substrate Wf to slowly rotate for estimation of a plating film thickness by a film thickness estimation module. As an example, the plating modules 400 may be adapted to cause the substrate Wf to rotate at a first rotation speed Rs1 during plating treatment and cause the substrate Wf to rotate at a second rotation speed Rs2 slower than the first rotation speed Rs1 while the substrate Wf rotates once or several times, for each predetermined period (for example, every several seconds). By doing so, it is possible to, especially even when the sampling period of the electrical potential sensors 460 is small relative to the rotation speed of the substrate Wf, accurately estimate the plating film thickness of the substrate Wf. Here, the second rotation speed Rs2 may be set to one-tenth the first rotation speed Rs1.

Thus, according to the plating apparatus 1000 of the present embodiment, it is possible to measure change in the film thickness of a plating film during plating treatment. It is possible to, with reference to the measured change in the film thickness of the plating film, adjust plating conditions including at least one of a value of a plating current, plating time, and a position of the shielding body 470 of the plating treatment. Note that the adjustment of the plating conditions may be performed by a user of the plating apparatus 1000 or by the control module 800. As an example, it is preferred that the adjustment of the plating conditions by the control module 800 is performed based on a conditional expression defined in advance through experiments or the like, a program, or the like. The adjustment of the plating conditions may be performed at the time of plating another substrate Wf, or adjustment of the plating conditions in the current plating treatment may be performed in real time. As an example of the adjustment of the plating conditions, the control module 800 may adjust forward/backward movement positions of the shielding body 470.

### Setting of Forward/Backward Movement Recipe for Shielding Body

In the plating apparatus 1000 of the present embodiment, forward/backward movement of the shielding body 470 between the shielding position and the retracted position is set by the control module (controller) 800 as a forward/backward movement recipe. FIG. 5 is a flowchart illustrating an example of a method for setting a forward/backward movement recipe by the control module 800. The forward/backward movement recipe setting method illustrated in FIG. 5 is executed at the time of performing treatment for a new substrate lot as an example. Note that, instead of being set by the control module 800 of the plating apparatus 1000, the forward/backward movement recipe may be set by a computer outside the plating apparatus 1000 and transmitted to the plating apparatus 1000. Hereinafter, the method for setting a forward/backward movement recipe by the control module 800 will be described. In this example, the control module 800 corresponds to an example of “a recipe setting module”.

First, the control module 800 acquires a resist pattern of a substrate Wf to be treated (step S12). The resist pattern means a pattern of a resist layer that is formed on the plating target surface Wf-a so that a desired plating pattern is formed by plating treatment. The acquisition of the resist pattern may be performed by the substrate Wf being detected by a sensor provided in the plating apparatus 1000. As an example, the plating apparatus 1000 may include an imaging sensor not illustrated, such as a camera for capturing an image of the plating target surface Wf-a of the substrate Wf. The control module 800 may acquire the resist pattern of the plating target surface Wf-a by acquiring imaging data detected by the imaging sensor and analyzing the imaging data. The acquisition of the resist pattern from the imaging data can be performed using a known method, based on shades or feature points of the imaging data. As another example, the plating apparatus 1000 may include a white light confocal sensor disposed to detect the plating target surface Wf-a. Then, the control module 800 may acquire the resist pattern of the plating target surface Wf-a by analyzing data input from the white light confocal sensor. Note that the detection by the white light confocal sensor may be performed, being accompanied by rotation of the substrate Wf. Furthermore, the acquisition of the resist pattern by the control module 800 may be performed by external input via wired or wireless communication as an example. In this case, information showing the resist pattern may be directly input to the control module 800. Alternatively, the control module 800 may acquire the resist pattern, by information related to the resist pattern, such as the imaging data described above, being input to the control module 800 and the control module 800 analyzing the input information.

Then, the control module 800 calculates a plating growth coefficient for each certain-angle area of the plating target surface Wf-a of the substrate Wf based on the acquired resist pattern (step S14). Here, the plating growth coefficient is a parameter indicating a growth speed (a formation speed) of a plating film in a state without considering effects of the shielding body 470, that is, in a state of the shielding body 470 being located at the retracted position. Further, the certain-angle area on the plating target surface Wf-a means an area surrounded by two straight lines connecting the center (the center of rotation) and outer edge of the plating target surface Wf-a, and the outer edge between the two straight lines, the central angle of the area being a certain angle. In other words, when the substrate Wf is circular, the certain-angle area means a fan-shaped area the central angle of which is the certain angle. As the certain angle, an angle of 360° divided equally is preferable, and is, for example, 0.5°, 1°, 2°, 5°, 6°, or 10° can be set. It is preferred that the certain-angle area is an area obtained by division based on an orientation flat, a notch, or the like formed on the substrate Wf.

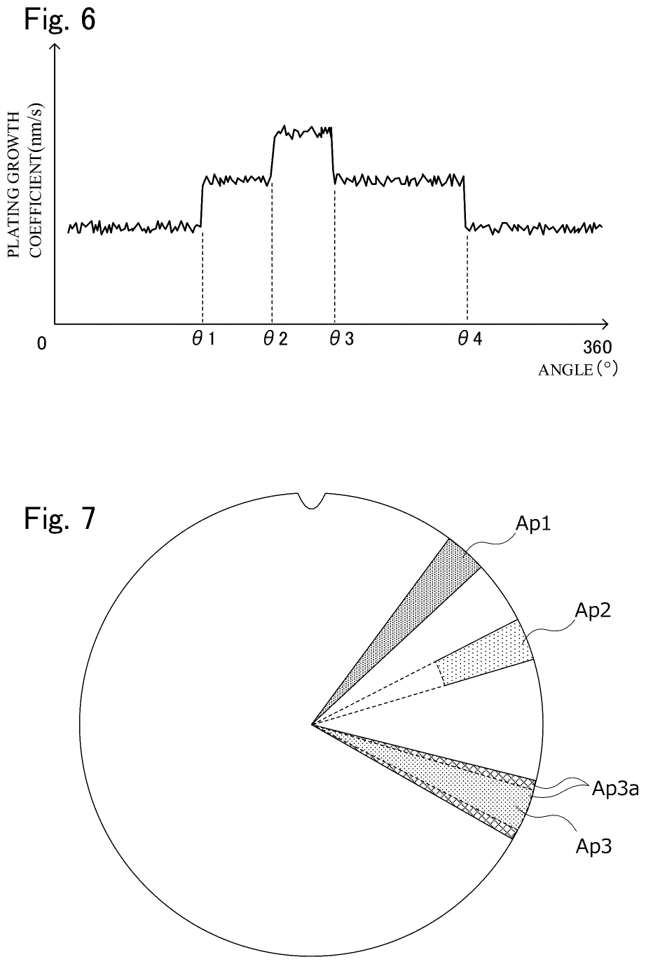

As an example, the plating growth coefficient can be an amount of plating film (for example, nanometers) formed in unit time (for example, one second). FIG. 6 is a graph illustrating an example of plating growth coefficients. In FIG. 6, the vertical axis indicates a plating growth coefficient for every one degree, and the horizontal axis indicates an angular position from a reference angle. Note that FIG. 6 illustrates that the plating growth coefficient is large in an area from θ1 to θ4 and is especially large in an area from θ2 to θ3. FIG. 7 is a diagram illustrating an example of an area on a plating target surface used for calculation of the plating growth coefficient. As an example, the plating growth coefficient can be calculated based on a resist pattern of an area Ap1 for which the plating growth coefficient is to be calculated. As another example, the plating growth coefficient may be calculated based on a resist pattern of an area Ap2 on the outer circumference side in a certain-angle area without considering an area close to the center (for example, an area corresponding to half the radius or less). As still another example, the plating growth coefficient may be calculated based on a resist pattern of an area Ap3a (an area including an area Ap3) that is larger than the area Ap3 for which the plating growth coefficient is to be calculated.

As a specific example, the control module 800 can calculate an aperture ratio (or an aperture amount) of the resist layer of each certain-angle area based on the resist pattern and calculate the plating growth coefficient based on the calculated aperture ratio (or the aperture amount). This is based on the fact that there is a tendency that, in an area where the aperture ratio of the resist layer is large, the area of accumulation of plating and the amount of plating for forming a predetermined amount of plating film are large, and the plating film growth speed is slower than that of an area where the aperture ratio of the resist layer is small. The control module 800, however, may calculate the plating growth coefficient based on other elements such as the length of the edge of the resist layer that occupies a certain-angle area, in addition to the aperture ratio of the resist layer.

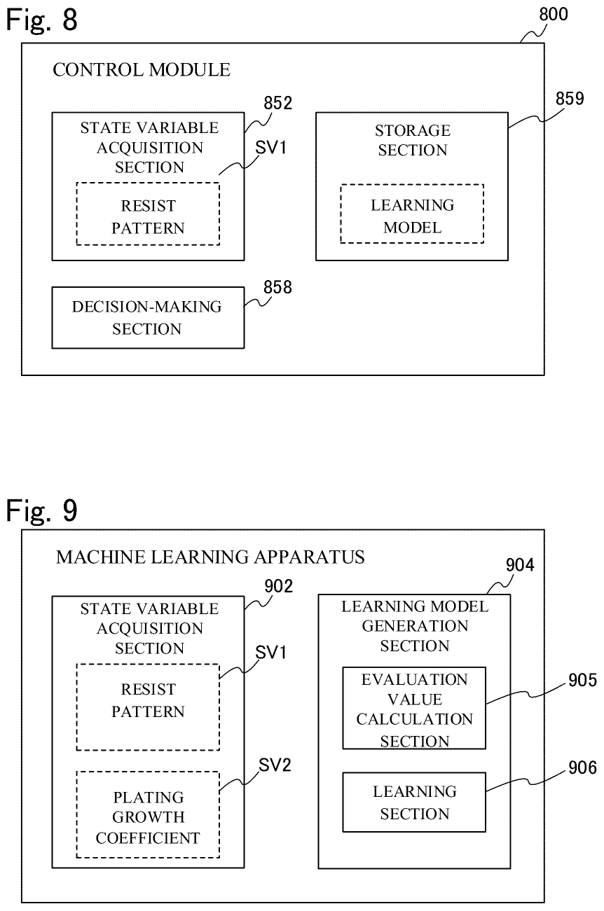

Further, the plating growth coefficient may be calculated using a learning model that has learned correlation between resist pattern and plating growth coefficient by machine learning. FIG. 8 is a schematic functional block diagram of the control module 800 in the present embodiment. The control module 800 includes a state variable acquisition section 852 that acquires a state variable (a resist pattern SV1), a storage section 859 in which the learning model is stored, and a decision-making section 858 that outputs (makes decision of) a plating growth coefficient for each certain-angle area, based on the acquired state variable (the resist pattern SV1) and the learning model.

In the present embodiment, the learning model stored in the storage section 859 is constructed by a machine learning apparatus. As an example, the plating apparatus 1000 wiredly or wirelessly acquires the learning model constructed by machine learning being performed in the machine learning apparatus, and stores the learning model into the storage section 859. Further, the plating apparatus 1000 may be mounted with the storage section 859 that stores the learning model constructed by the machine learning apparatus in advance. Note that, though the machine learning apparatus is shown as a component different from the control module 800 of the plating apparatus 1000 in the present embodiment, the control module 800 may be adapted to perform at least a part of the functions of the machine learning apparatus. As an example, the machine learning apparatus can be configured with a microcomputer that includes a CPU, a memory, and the like and realizes predetermined functions using software. FIG. 9 is a schematic functional block diagram of the machine learning apparatus in the present embodiment. The machine learning apparatus includes a state variable acquisition section 902 that acquires state variables (the resist pattern SV1 and a plating growth coefficient SV2) as learning data and a learning model generation section 904 that learns/generates a learning model based on the acquired state variables.

The state variable acquisition section 902 acquires the resist pattern SV1 of the substrate Wf and the plating growth coefficient SV2 at the time when plating treatment has been applied to the substrate Wf with the resist pattern SV1. The resist pattern SV1 can be acquired by a method similar to the method for acquisition of a resist pattern by the control module 800 described above, and may be acquired by acquiring and analyzing image data as an example.

The plating growth coefficient SV2 may be acquired based on a parameter about the film thickness of a plating film (plating film thickness information) at the time when plating treatment has been applied to the substrate Wf with the resist pattern SV1. The plating film thickness information may be values detected by the sensors 460 provided in the plating apparatus 1000 or may be a plating film thickness measured by the control module 800 based on the values detected by the sensors 460. Furthermore, the plating film thickness information may be a plating film thickness measured for the substrate Wf for which plating treatment has been completed. Further, the plating film thickness information may be information measured when plating treatment has been applied without using the shielding body 470, or may be information measured when plating treatment has been applied, being accompanied by forward/backward movement of the shielding body 470. When plating treatment has been applied, being accompanied by forward/backward movement of the shielding body 470, however, it is preferred to acquire information SV3 showing a forward/backward movement recipe for or a movement history of the shielding body 470 and calculate a plating growth coefficient in consideration of forward/backward movement of the shielding body 470. Further, the plating growth coefficient SV2 may be calculated in consideration of other information, such as a plating current value and a plating time, in addition to the plating film thickness information.

The learning model generation section 904 learns the learning model (correlation between the resist pattern SV1 and the plating growth coefficient SV2) in accordance with an arbitrary learning algorithm that is generically referred to as machine learning. The learning model generation section 904 repeatedly executes learning based on the state variables (the resist pattern SV1 and the plating growth coefficient SV2) acquired by the state variable acquisition section 902. The learning model generation section 904 acquires a plurality of state variables and interprets the correlation by identifying characteristics of the state variables. Note that the learning model generation section 904 may input the resist pattern SV1 and the plating film thickness information to the learning model to learn the learning model with the resist pattern SV1 and the plating growth coefficient SV2.

Then, the decision-making section 858 of the control module 800 judges a plating growth coefficient for each certain-angle area based on the learning model constructed by the machine learning and the resist pattern SV1 acquired by the state variable acquisition section 852 of the control module 800.

Referring to FIG. 5, the control module 800 sets a forward/backward movement recipe for the shielding body 470 based on the calculated plating growth coefficient for each certain-angle area (step S16). Here, the forward/backward movement recipe for the shielding body 470 is a recipe showing a forward/backward movement position of the shielding body 470 for each angular position of the substrate Wf. For example, the control module 800 sets the forward/backward movement recipe for the shielding body 470 so that the shielding body 470 is located at the shielding position in an area with a large plating growth coefficient and is located at the retracted position in an area with a small plating growth coefficient. Note that the control module 800 may normalize the plating growth coefficients of the certain-angle areas and set the forward/backward movement recipe for the shielding body 470 based on normalized plating growth coefficients. Here, “normalization” means to perform linear transformation so that the minimum and maximum values are a value 0 and a value 1, respectively, as an example.

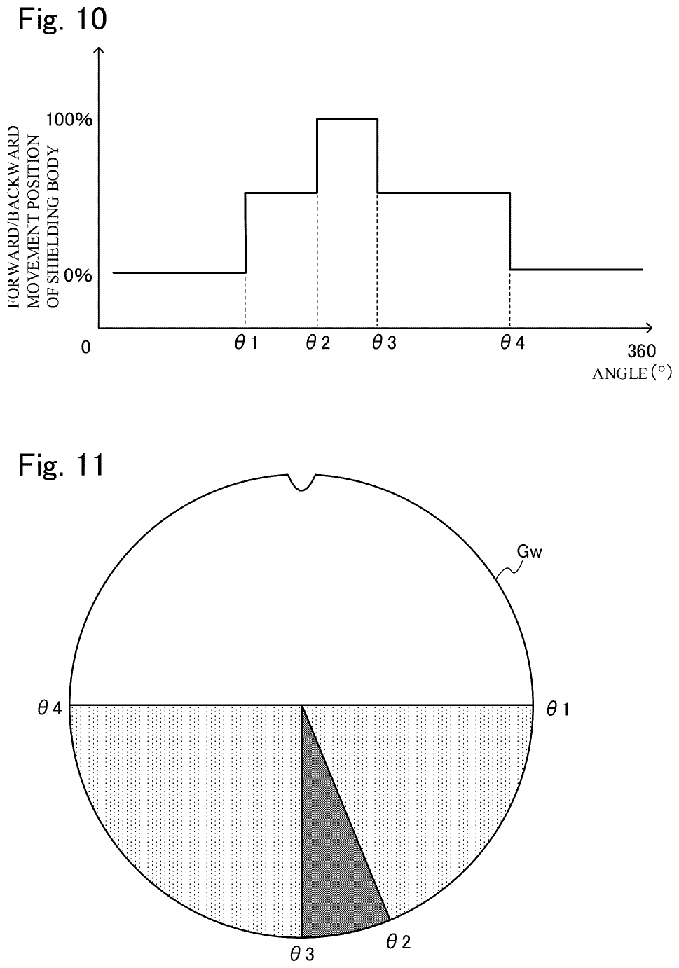

FIG. 10 is a graph illustrating an example of the forward/backward movement position of the shielding body for each angular position of the substrate Wf, as the forward/backward movement recipe. Note that FIG. 10 illustrates an example of the forward/backward movement recipe for the shielding body 470, for a substrate Wf with the plating growth coefficients of the certain-angle areas illustrated in FIG. 6. In FIG. 10, the vertical axis indicates the forward/backward movement position of the shielding body 470, and the horizontal axis indicates the angular position from a reference angle. Further, in FIG. 10, as for the forward/backward movement position of the shielding body 470, a position where the amount of interposition of the shielding body 470 between the substrate Wf and the anode 430 is the largest is indicated as 100%, and a position where the shielding body 470 is retracted from between the substrate Wf and the anode 430 is indicated as 0%. Furthermore, FIG. 10 illustrates an example in which the amount of interposition of the shielding body 470 between the substrate Wf and the anode 430 is adjustable.

The forward/backward movement recipe for the shielding body 470 may be calculated using a learning model that has learned correlation between plating growth coefficient and forward/backward movement recipe by machine learning. Referring to FIG. 8, the decision-making section 858 of the control module 800 may output a forward/backward movement recipe together with plating growth coefficients. In this case, correlation among the resist pattern SV1, the plating growth coefficient SV2, and a forward/backward movement recipe SV3 is machine-learned by the learning model. Here, the learning model generation section 904 may learn the learning model by executing reinforcement learning. The reinforcement learning is a method in which, in a certain environment, reward is given to an action (output) executed for a current state (input), and such a learning model that the biggest reward can be obtained is generated. In an example of performing the reinforcement learning, the learning model generation section 904 includes an evaluation value calculation section 905 that calculates an evaluation value based on the state variables SV and a learning section 906 that performs learning of a learning model based on the evaluation value. As an example, the evaluation value calculation section 905 calculates the evaluation value based on plating treatment at the time when the shielding body 470 is driven relative to the substrate Wf with the resist pattern SV1, based on the forward/backward movement recipe SV3. Specifically, a bigger reward may be given as time required for the plating treatment of the substrate Wf is shorter. Further, the evaluation value calculation section 905 may give a bigger reward as the plating growth coefficient SV2 is more constant. Furthermore, the evaluation value calculation section 905 may give a bigger reward as the uniformity of a plating film formed on the substrate Wf is higher.

When the forward/backward movement recipe for the shielding body 470 is set, the control module (controller) 800 controls the drive mechanism 472 based on the forward/backward movement recipe to cause the shielding body 470 to move forward/backward during plating treatment of the substrate Wf. Thereby, it is possible to improve the uniformity of a plating film formed on the substrate Wf.

### Display of Plating Growth Coefficient or Forward/Backward Movement Recipe for Shielding Body

The control module 800 may display plating growth coefficient information showing plating growth coefficients calculated based on a resist pattern and/or information about a forward/backward movement recipe for the shielding body 470 on a display section 802 (see FIG. 2). FIG. 11 is a diagram illustrating an example of display of the plating growth coefficient for each certain-angle area or the forward/backward movement recipe for the shielding body 470 on the display section 802. In the example illustrated in FIG. 11, a substrate graphic Gw modeled after the substrate Wf is displayed. Further, plating growth coefficient information or information showing a forward/backward movement position of the shielding body 470 is illustrated in association with each angular position of the substrate graphic Gw.

To describe an example of plating growth coefficients, the plating growth coefficients illustrated in FIG. 6 are illustrated, in the example illustrated in FIG. 11. For example, in the example illustrated in FIG. 6, the plating growth coefficient is small at angles between 0° and θ1, a little large at angles between θ1 and θ2, and especially large at angles between θ2 and θ3. In order to indicate such plating growth coefficients, parts of the substrate graphic Gw corresponding to angles between 0° and θ1, angles between θ1 and θ2, and angles between θ2 and θ3 are indicated in different colors (hatchings), respectively, in the example illustrated in FIG. 11.

Similarly, to describe an example of forward/backward movement positions of the shielding body 470, the forward/backward movement recipe illustrated in FIG. 10 is illustrated in the example illustrated in FIG. 11. For example, in the example illustrated in FIG. 10, the shielding body 470 is located at the retracted position at an angle between 0° and θ1, a little interposed between the substrate Wf and the anode 430 at an angle between θ1 and θ2, and located at a position of being most interposed between the substrate Wf and the anode 430 at an angle between θ2 and θ3. In order to indicate such a forward/backward movement recipe, parts of the substrate graphic Gw corresponding to the angles between 0° and θ1, the angles between θ1 and θ2, and the angles between θ2 and θ3 are indicated in the different colors (hatchings), respectively, in the example illustrated in FIG. 11.

As an example, the control module 800 can specify relationships between plating growth coefficients (or forward/backward movement positions of the shielding body 470) and colors in advance, and set colors to be displayed on the display section 802 based on the relationship and plating growth coefficients (or forward/backward movement positions of the shielding body 470). Further, instead of or in addition to colors, the control module 800 may specify relationships between plating growth coefficients (or forward/backward movement positions of the shielding body 470) and figures, patterns, or characters in advance and set display on the display section 802 based on the relationships and plating growth coefficients (or forward/backward movement positions of the shielding body 470). Note that the control module 800 may perform display on the display section 802 using plating growth coefficients normalized for certain-angle areas, respectively, instead of the plating growth coefficients. Note that the control module 800 may display the graphs illustrated in FIGS. 6 and 10 on the display section 802 instead of or in addition to the display illustrated in FIG. 11.

By the plating growth coefficient information or the information showing the forward/backward movement recipe for the shielding body 470 being displayed on the display section 802 as above, the user can intuitively understand the forward/backward movement recipe for the shielding body 470 through vision. Note that the control module 800 may accept input of modification of the set forward/backward movement recipe by the user. It is possible to, by causing the shielding body 470 to perform forward/backward movement using the forward/backward movement recipe set in this way, improve uniformity of a plating film formed on the substrate Wf.

The present invention can also be described as following aspects.

[Aspect 1] According to Aspect 1, there is proposed a method for, in a computer, setting a forward/backward movement recipe for a shielding body in a plating apparatus, the plating apparatus including the shielding body, the shielding body being movable to a shielding position interposed between a plating target surface of a substrate and an anode and to a retracted position retracted from between the plating target surface of the substrate and the anode, and the method includes steps of: acquiring a resist pattern of the substrate; calculating a plating growth coefficient for each certain-angle area of the substrate based on the acquired resist pattern; and setting the forward/backward movement recipe for the shielding body based on the calculated plating growth coefficient for each certain-angle area.

According to Aspect 1, it is possible to, by causing the shielding body to perform forward/backward movement based on the forward/backward movement recipe for the shielding body, improve uniformity of a plating film formed on the substrate.

[Aspect 2] According to Aspect 2, in Aspect 1, at the step of acquiring the resist pattern of the substrate, the resist pattern of the substrate is acquired by acquiring imaging data of the substrate and analyzing the imaging data.

According to Aspect 2, it is possible to set the forward/backward movement recipe for the shielding body based on the imaging data of the substrate.

[Aspect 3] According to Aspect 3, in Aspect 1 or 2, at the step of calculating the plating growth coefficient for each certain-angle area, an aperture ratio of a resist layer for each certain-angle area of the substrate is calculated based on the resist pattern, and the plating growth coefficient for each certain-angle area is calculated based on the calculated aperture ratio.

According to Aspect 3, it is possible to calculate the plating growth coefficient based on the calculated aperture ratio of the resist layer.

[Aspect 4] According to Aspect 4, in Aspects 1 to 3, there is included a step of displaying information showing a forward/backward movement position of the shielding body for each angular position of the substrate on a display section as the forward/backward movement recipe.

According to Aspect 4, it is possible to intuitively understand the forward/backward movement recipe for the shielding body through vision.

[Aspect 5] According to Aspect 5, in Aspects 1 to 4, there is included a step of displaying plating growth coefficient information showing the calculated plating growth coefficient for each certain-angle area of the substrate, on the display section.

According to Aspect 5, it is possible to intuitively understand the forward/backward movement recipe for the shielding body by seeing the display of the plating growth coefficient information.

[Aspect 6] According to Aspect 6, in Aspects 1 to 5, the plating growth coefficient information is information obtained by normalizing the plating growth coefficient for each certain-angle area.

According to Aspect 6, it is possible to more easily understand the plating growth coefficient.

[Aspect 7] According to Aspect 7, in Aspect 5, at the step of displaying the plating growth coefficient information on the display section, a substrate graphic modeled after the substrate is displayed, and the plating growth coefficient information is displayed for each certain-angle area in the substrate graphic.

According to Aspect 7, it is possible to more easily understand the plating growth coefficient.

[Aspect 8] According to Aspect 8, in Aspect 7, as the plating growth coefficient information, a figure, a pattern, a character, a color, or a combination thereof specified in advance is displayed for the plating growth coefficient for each certain-angle area or for the normalized plating growth coefficient for each certain-angle area.

According to Aspect 8, it is possible to more easily understand the plating growth coefficient.

[Aspect 9] According to Aspect 9, in Aspects 1 to 8, there are included steps of: acquiring a parameter related to a film thickness of a plating film formed on the plating target surface of the substrate during plating treatment; and inputting the parameter and the resist pattern that have been acquired, to a learning model to perform learning of the learning model; and at the step of calculating the plating growth coefficient for each certain-angle area, the plating growth coefficient for each certain-angle area is calculated by inputting the acquired resist pattern to the learning model.

According to Aspect 9, it is possible to set the forward/backward movement recipe for the shielding body using machine learning.

[Aspect 10] According to Aspect 10, there is proposed a plating apparatus, and the plating apparatus includes: a plating tank; a substrate holder for holding a substrate; an anode disposed in the plating tank to face the substrate held by the substrate holder; a shielding body movable to a shielding position interposed between a plating target surface of the substrate and the anode and to a retracted position retracted from between the plating target surface of the substrate and the anode; a recipe setting module calculating a plating growth coefficient for each certain-angle area of the substrate based on a resist pattern of the substrate and setting a forward/backward movement recipe for the shielding body based on the calculated plating growth coefficient for each certain-angle area; and a controller controlling the shielding body based on the forward/backward movement recipe during plating treatment.

According to Aspect 10, it is possible to improve uniformity of a plating film formed on the substrate.

An embodiment of the present invention has been described above. The embodiment of the present invention described above, however, is intended to facilitate understanding of the present invention and are not intended to limit the present invention. As an example, the embodiment of the present invention described above is also applicable to a so-called dip-type plating apparatus in which a substrate and an anode are vertically arranged. Needless to say, the present invention can be changed or modified without departing from the spirit thereof, and the present invention includes equivalents thereof. Further, within a range in which at least a part of the problem described above can be solved or a range in which at least a part of effects are exhibited, an arbitrary combination among the embodiment and modifications is possible, an arbitrary combination or omission of the components described in the claims and the specification is possible.

The present application claims priority based on Japanese Patent Application No. 2023-196616 filed on Nov. 20, 2023. The disclosed content of Japanese Patent Application No. 2023-196616, including the specification, claims, drawings, and abstract thereof, is incorporated in the present application by reference in its entirety. The disclosed content of each of Japanese Patent Laid-Open No. 2005-29863 (PTL 1) and Japanese Patent No. 7074937 (PTL 2), including the specification, claims, drawings, and abstract thereof, is incorporated in the present application by reference in its entirety.

### REFERENCE SIGNS LIST

400 plating module
410 plating tank
430 anode
440 substrate holder
448 rotation mechanism
460 sensor
470 shielding body
472 drive mechanism
800 control module
802 display section
852 state variable acquisition section
858 decision-making section
859 storage section
902 state variable acquisition section
904 learning model generation section
905 evaluation value calculation section
906 learning section
1000 plating apparatus
Wf substrate

What is claimed is:

1. A method for, in a computer, setting a forward/backward movement recipe for a shielding body in a plating apparatus, the plating apparatus comprising the shielding body, the shielding body being movable to a shielding position interposed between a plating target surface of a substrate and an anode and to a retracted position retracted from between the plating target surface of the substrate and the anode, and the method comprising steps of:
acquiring a resist pattern of the substrate;
calculating a plating growth coefficient for each certain-angle area of the substrate based on the acquired resist pattern; and
setting the forward/backward movement recipe for the shielding body based on the calculated plating growth coefficient for each certain-angle area.

2. The method according to claim 1, wherein, at the step of acquiring the resist pattern of the substrate, the resist pattern of the substrate is acquired by acquiring imaging data of the substrate and analyzing the imaging data.

3. The method according to claim 1, wherein, at the step of calculating the plating growth coefficient for each certain-angle area, an aperture ratio of a resist layer for each certain-angle area of the substrate is calculated based on the resist pattern, and the plating growth coefficient for each certain-angle area is calculated based on the calculated aperture ratio.

4. The method according to claim 1, comprising a step of displaying information showing a forward/backward movement position of the shielding body for each angular position of the substrate on a display section as the forward/backward movement recipe.

5. The method according to claim 1, comprising a step of displaying plating growth coefficient information showing the calculated plating growth coefficient for each certain-angle area of the substrate, on the display section.

6. The method according to claim 5, wherein the plating growth coefficient information is information obtained by normalizing the plating growth coefficient for each certain-angle area.

7. The method according to claim 5, wherein, at the step of displaying the plating growth coefficient information on the display section, a substrate graphic modeled after the substrate is displayed, and the plating growth coefficient information is displayed for each certain-angle area in the substrate graphic.

8. The method according to claim 7, wherein, as the plating growth coefficient information, a figure, a pattern, a character, a color, or a combination thereof specified in advance is displayed for the plating growth coefficient for each certain-angle area or for the normalized plating growth coefficient for each certain-angle area.

9. The method according to claim 1, comprising steps of:
acquiring a parameter related to a film thickness of a plating film formed on the plating target surface of the substrate during plating treatment; and
inputting the parameter and the resist pattern that have been acquired, to a learning model to perform learning of the learning model; wherein
at the step of calculating the plating growth coefficient for each certain-angle area, the plating growth coefficient for each certain-angle area is calculated by inputting the acquired resist pattern to the learning model.

10. A plating apparatus comprising:
a plating tank;
a substrate holder for holding a substrate;
an anode disposed in the plating tank to face the substrate held by the substrate holder;
a shielding body movable to a shielding position interposed between a plating target surface of the substrate and the anode and to a retracted position retracted from between the plating target surface of the substrate and the anode;
a recipe setting module calculating a plating growth coefficient for each certain-angle area of the substrate based on a resist pattern of the substrate and setting a forward/backward movement recipe for the shielding body based on the calculated plating growth coefficient for each certain-angle area; and
a controller controlling the shielding body based on the forward/backward movement recipe during plating treatment.
